(19) United States
(12) Patent Application Publication
(10) Pub. No.: US 2019/0018384 A1
(43) Pub. Date: Jan. 17, 2019

(54) PLANT ANALYZER, PLANT ANALYSIS METHOD, AND PROGRAM THEREOF

(71) Applicant: Mitsubishi Hitachi Power Systems, Ltd., Kanagawa (JP)

(72) Inventors: Yasuoki TOMITA, Yokohama-shi (JP); Katsuhiko ABE, Yokohama-shi (JP); Shintaro KUMANO, Tokyo (JP); Motoshi TAKASU, Yokohama-shi (JP); Etsushi KANNO, Yokohama-shi (JP); Takahiro KAWAGUCHI, Yokohama-shi (JP); Masao OGINO, Yokohama-shi (JP)

(21) Appl. No.: 16/069,298

(22) PCT Filed: Dec. 8, 2016
(86) PCT No.: PCT/JP2016/086542

§ 371 Date: Jul. 11, 2018

(30) Foreign Application Priority Data
Jan. 14, 2016 (JP) 2016-005336

(51) Int. Cl. G05B 19/042; F01D 21/00; F02C 6/18

(52) U.S. Cl. CPC G05B 19/0428; F01D 21/003; F02C 6/18; F05D 2220/32; G05B 2219/2619; F05D 2220/76; F05D 2260/80; G05B 2219/2639; F05D 2220/31

(57) ABSTRACT

A state quantity acquiring unit is configured to acquire a state quantity of a turbine including a temperature of the turbine. A variable calculation unit is configured to calculate a history variable with respect to a history of the state quantity. A time calculation unit is configured to calculate the operable time at an over firing operation of the turbine based on a history variable corresponding to a design life of the turbine and a calculated history variable.

### TECHNICAL FIELD

The present invention relates to a plant analyzer, a plant analysis method, and a program thereof.

This application claims priority right to Japanese Patent Application No. 2016-005336 filed in Japan on Jan. 14, 2016, the content of which is incorporated herein by reference.

### BACKGROUND TECHNOLOGY

In thermal power plants equipped with gas turbine and steam turbine, an operation at base load (rated load, 100% load) and an operation at partial load (for example, 75% load) are operated according to electric power demand. Further, Patent Document 1 discloses a technique for performing an over firing operation by determining whether or not the over firing operation (heavy load operation) is possible by a cumulative load of gas turbine components. The over firing operation means to operate a turbine at a load (for example, 110% load) higher than the load of a base load operation (100% load).

### PRIOR ART DOCUMENT

### Patent Document

### [Patent Document 1] Japanese Unexamined Patent Publication No. 2003-13744

### SUMMARY OF THE INVENTION

### Problems to be Solved by the Invention

In the technique disclosed in Patent Document 1, the maintenance component is prevented from being damaged during the heavy load operation by determining whether or not it is possible to secure a predetermined operation maintenance period determined from the replacement timing of the maintenance components in a case where the heavy load operation calculated from the cumulative load of maintenance components of a gas turbine is carried out. However, the maintenance components have not been designed to be operated under heavy load. Therefore, by carrying out the heavy load operation, the maintenance components may be broken earlier than the period determined by various factors.

The object of the present invention is to provide a plant analyzer capable of accurately calculating an operable time at an over firing operation based on a state quantity of a turbine, a plant analysis method, and a program thereof.

### Means for Solving the Problem

A first aspect of the present invention provides a plant analyzer comprising: a state quantity acquiring unit configured to acquire a state quantity of a turbine including a temperature of the turbine; a variable calculation unit configured to calculate a history variable with respect to a history of the state quantity; and a time calculation unit configured to calculate an operable time at an over firing operation of the turbine based on a history variable corresponding to a design life of the turbine and a calculated history variable.

A second aspect of the present invention provides the plant analyzer according to the first aspect further comprising: a first determination unit configured to determine whether or not the over firing operation of the turbine is possible based on the operable time calculated by the time calculation unit.

A third aspect of the present invention provides the plant analyzer according to the first or second aspect, and the time calculation unit is configured to calculate the operable time to prevent the turbine from reaching the product life until the turbine inspection timing.

A fourth aspect of the present invention provides the plant analyzer according to the first or second aspect further comprising: an inspection timing determination unit configured to determine the inspection timing of the turbine based on the operable time calculated by the time calculation unit.

A fifth aspect of the present invention provides the plant analyzer according to any one of the first to fourth aspects further comprising: a distance calculation unit configured to calculate a Mahalanobis distance based on the state quantity; and a second determination unit configured to determine whether or not the over firing operation of the turbine is possible by the Mahalanobis distance.

A sixth aspect of the present invention provides the plant analyzer according to any one of the first to fifth aspects further comprising: a third determination unit configured to determine whether or not the over firing operation of the turbine is possible based on whether or not a power selling price is less than a predetermined threshold.

A seventh aspect of the present invention provides a plant analysis method comprising the steps of: acquiring a state quantity of a turbine including the temperature of the turbine; calculating a history variable with respect to a history of the state quantity; and calculating an operable time at the over firing operation of the turbine based on a history variable corresponding to a design life of the turbine and a calculated history variable.

A eighth aspect of the present invention provides a program to function a computer as: a state quantity acquiring unit configured to acquire a state quantity of a turbine including a temperature of a turbine; a variable calculation unit configured to calculate a history variable with respect to a history of the state quantity; and a time calculation unit configured to calculate an operable time at the over firing operation of the turbine based on a history variable corresponding to the design life of the turbine and the calculated history variable.

### Effect of Invention

According to at least one aspect of the above described aspects, the plant analyzer calculates a temperature history variable based on a state quantity including a temperature of a turbine, and calculates the operable time in an over firing operation from the temperature history variable. The turbine strain increases as temperature increases. Thus, the plant analyzer can accurately specify the remaining life of the turbine by managing turbine life based on the turbine temperature history. Therefore, the plant analyzer can accurately calculate the operable time at the over firing operation.

### BRIEF DESCRIPTION OF DRAWINGS

FIG. 1 is a schematic diagram of a power plant according to an example of an analysis target.

FIG. 2 is a schematic block diagram showing a configuration of a plant analyzer according to a first embodiment.

FIG. 3 is a flow chart showing an operation of a collecting cycle of the plant analyzer according to the first embodiment.

FIG. 4 is a flow chart showing a determining operation whether or not an over firing operation by the plant analyzer according to the first embodiment is possible.

FIG. 5 shows an example of proposal information outputted by the plant analyzer according to the first embodiment.

FIG. 6 is a flow chart showing a determining operation whether or not an over firing operation by a plant analyzer according to the second embodiment is possible.

FIG. 7 shows an example of proposal information outputted by the plant analyzer according to the second embodiment.

FIG. 8 is a schematic block diagram showing a configuration of a plant analyzer according to a third embodiment.

FIG. 9 is a flow chart showing a determining operation of an inspection timing by the plant analyzer according to the third embodiment.

FIG. 10 is a schematic block diagram illustrating a computer configuration according to at least one embodiment.

### MODE FOR CARRYING OUT THE INVENTION

### First Embodiment

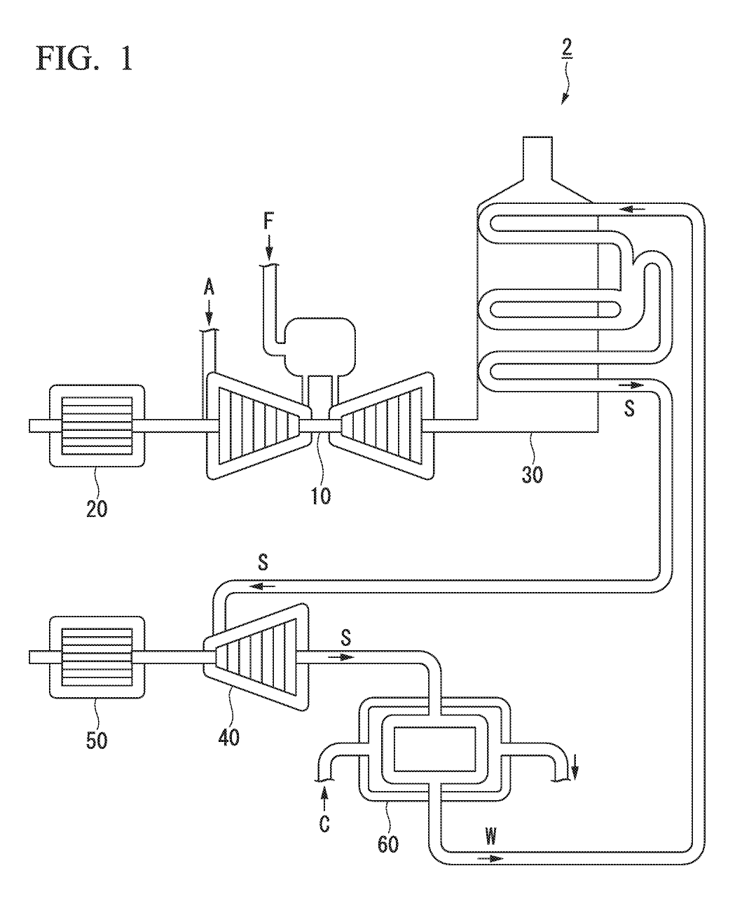

A first embodiment will be described in detail below with reference to the drawings. FIG. 1 is a schematic diagram of a power plant according to an example of an analysis target.

The plant analyzer 1 determines whether or not an over firing operation of a turbine provided a power plant 2 is possible. In the present embodiment, the power plant 2 which is a target of analysis of the plant analyzer 1 is a GTCC plant equipped with a gas turbine and a steam turbine as shown in FIG. 1. The power plant 2 shown in FIG. 1 includes a gas turbine 10, a first generator 20, a waste heat recovery boiler 30, a steam turbine 40, a second generator 50, and a condenser 60. The gas turbine 10 is driven by a high-temperature and high-pressure combustion gas generated by compressing air A and combusting fuel F in the compressed air. The first generator 20 generates electricity by the drive of the gas turbine 10. The waste heat recovery boiler 30 generates steam S by heat of an exhaust gas from the gas turbine 10. The steam turbine 40 is driven by the steam S from the waste heat recovery boiler 30. The second generator 50 generates electricity by the drive of the steam turbine 40. The condenser 60 returns the steam S exhausted from the steam turbine 40 to a steam condensate W by cooling the steam S with the coolant C. The steam condensate W returned by the condenser 60 is supplied to the waste heat recovery boiler 30. In addition, the power plant 2 shown in FIG. 1 is an example of an analysis target, and the analysis target of the plant analyzer 1 may be another thermal power plant such as a conventional plant.

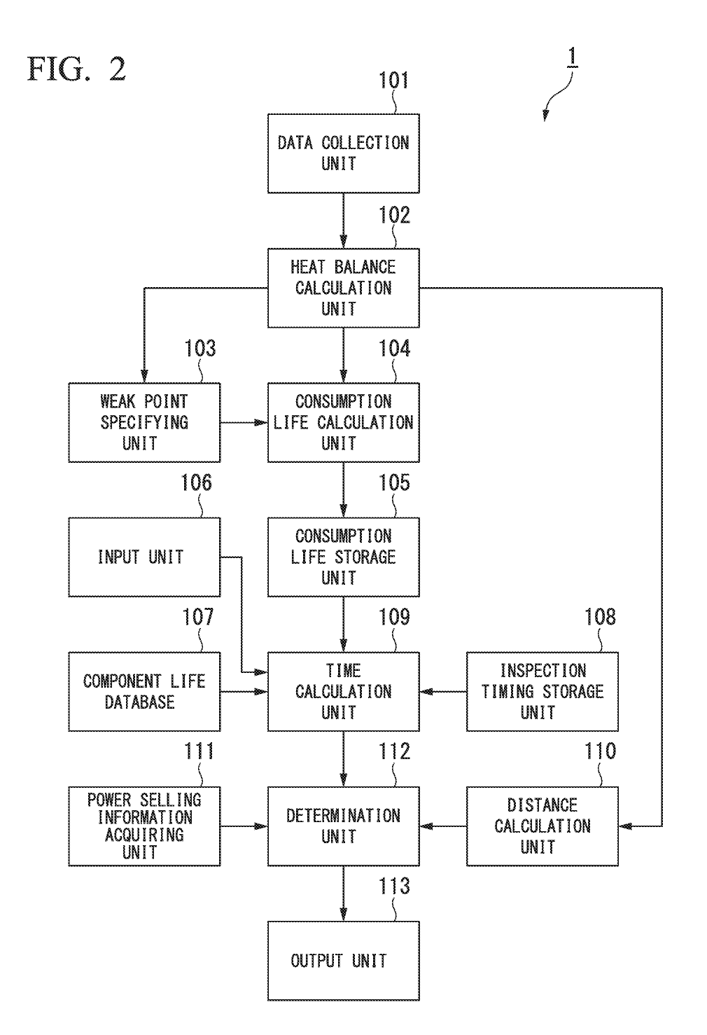

FIG. 2 is a schematic block diagram showing a configuration of a plant analyzer according to a first embodiment.

The plant analyzer 1 includes a data collection unit 101, a heat balance calculation unit 102, a weak point specifying unit 103, a consumption life calculation unit 104, a consumption life storage unit 105, an input unit 106, a component life database 107, an inspection timing storage unit 108, a time calculation unit 109, a distance calculation unit 110, a power selling information acquiring unit 111, a determination unit 112, and an output unit 113.

The data collection unit 101 collects an operation data of the power plant 2, such as a turbine, in real time from the power plant 2. Specifically, the data collection unit 101 collects an operation data from a sensor provided in the turbine or the like at a predetermined collection cycle (e.g., 5 minutes). The collection cycle is a short period of time so that the immediacy of monitoring is not lost. The operation data is collected regardless of whether a power plant is in operation. Examples of operating data include flow rate, pressure, temperature, vibration, and other state quantities. The sensor provided in the turbine may include a sensor for a special measurement in addition to a commonly used sensor. Examples of the sensor for special measurement include sensor for measuring a gas temperature of the fluid which has spent its workload in the final stage blade and a chip clearance sensor for measuring a gap between a blade tip and a chamber. The data collection unit 101 is an example of a state quantity collecting unit for acquiring a state quantity of the turbine.

The heat balance calculation unit 102 calculates a heat balance of the power plant 2, such as the turbine, based on the operation data collected by the data collection unit 101. The heat balance means temperature, pressure, enthalpy, flow rate, and other state quantities in each of a plurality of parts of the power plant 2, such as the turbine. The heat balance calculation unit 102 calculates the heat balance by simulation based on the operation data. Examples of a simulation method for calculating the heat balance include Finite Element Method (FEM) and Computational Fluid Dynamics (CFD). The heat balance calculation unit 102 is an example of the state quantity collecting unit for acquiring a state quantity of a turbine.

The weak point specifying unit 103 specifies a component of the turbine that becomes the highest temperature in all components of the turbine during high load operation based on the heat balance calculated by the heat balance calculation unit 102.

The consumption life calculation unit 104 calculates the LMP (Larson-Miller Parameter) value Lc indicating a degradation amount of each component in the latest collection cycle based on the heat balance calculated by the heat balance calculation unit 102. In other words, the consumption life calculation unit 104 is an example of a variable calculation unit for calculating a history variable relating to history of state quantities. The LMP value is a parameter determined by Equation (1) below.

[Equation 1]

L_{c}=T_{c}(log t+C) (1)

Tc denotes a thermodynamics temperature of a component. The thermodynamics temperature is equivalent to the Celsius temperature plus 273.15. The thermodynamics temperature of the component is specified by the temperature of a region specified by the weak point specifying unit 103 among the heat balance calculated by the heat balance calculation unit 102. T denotes an operating time of the turbine at the temperature Tc. That is, the time t is equal to the collection cycle by the data collection unit 101. C is a constant defined by the material of the component. For example, when the material of the component is a low carbon steel or chromium molybdenum steel, the constant C may be 20. Also, when the material of the component is stainless steel, the constant C may be 15.

Thus, the LMP value is a parameter specified from the thermodynamics temperature of the component and the operating time. That is, the LMP value is an example of a history variable relating to a history of the temperature applied on a component. The LMP value can represent the state of creep deformation.

Further, the consumption life calculation unit 104 calculates a consumption life tc of the component converted by a rated temperature Ts of the component according to the following equation (2) based on the calculated LMP value Lc.

$$\begin{matrix}[ Equation 2 ] & \\ {t}_{c} = {10}^{\frac{{L}_{c}}{Ts} - C} & ( 2 )\end{matrix}$$

The consumption life storage unit 105 stores an integrated value (hereinafter referred to as a cumulative consumption life Σtc) of the consumption life tc calculated by the consumption life calculation unit 104 for each component of the turbine.

The input unit 106 receives an input of an execution command of a process of determining whether or not the over firing operation is possible from an operator. For example, the input unit 106 receives the input of the execution command by pressing a determination start button.

The component life database 107 stores a design life ts and a rated temperature Tc of each component of the turbine.

The inspection timing storage unit 108 stores a predetermined inspection timing of a turbine. The inspection timing is the date and time designated by the operator of the plant analyzer 1.

The time calculation unit 109 calculates the operable time to in the over firing operation of the turbine based on the cumulative consumption life Σtc of each component, the design life ts of each component, and the inspection timing of the turbine. Specifically, the time calculation unit 109 calculates a remaining life ti of the component by subtracting the cumulative consumption life Σtc from the design life ts. The remaining life tl is an operable time of the component at the rated temperature Tc. The time calculation unit 109 calculates the LMP value Ll according to the following equation (3) based on the calculated remaining life tl and the rated temperature Tc of the component. Then, the time calculation unit 109 calculates the operable time to which is for preventing all components from reaching the product life until the inspection timing based on the LMP value Ll and the over firing temperature To according to the following equation (4).

$$\begin{matrix}[ Equation 3 ] & \\ {L}_{l} = {T}_{s} ( log {t}_{1} + C ) & ( 3 ) \\ [ Equation 4 ] & \\ {t}_{o} = {10}^{\frac{{L}_{l}}{{T}_{o}} - C} & ( 4 )\end{matrix}$$

The distance calculation unit 110 calculates a Mahalanobis distance of the turbine based on the heat balance calculated by heat balance calculation unit 102. The Mahalanobis distance indicates the degree of divergence between the state of a turbine at a specific time and a normal state thereof. Specifically, the distance calculation unit 110 calculates the Mahalanobis distance by projecting the heat balance calculated by the heat balance calculation unit 102 in a unit space constituted by a plurality of state quantities acquired from a turbine in the past. The unit space refers to a data group that is a basis for calculating the Mahalanobis distance. In addition, the Mahalanobis distance is a distance that is weighted in accordance with a dispersion or correlation of the state quantities in the unit space, and the Mahalanobis distance becomes larger as the degree of similarity with the data group in the unit space is lower.

The power selling information acquiring unit 111 acquires a power selling information indicating a current power selling price. The power selling information acquiring unit 111 may acquire the power selling information from an external server via the Internet, or the power selling information may be input by the operator.

The determination unit 112 determines whether or not the over firing operation of the turbine is possible based on the operable time calculated by the time calculation unit 109, the Mahalanobis distance calculated by the distance calculation unit 110, and the power selling information acquired by the power selling information acquiring unit 111. The determination unit 112 determines that the over firing operation should not be carried out when the operable time is less than a predetermined time. In addition, the determination unit 112 determines that the over firing operation should not be carried out when the Mahalanobis distance exceeds a predetermined distance. In addition, the determination unit 112 determines that the over firing operation should not be carried out when the power selling price indicated by the power selling information is less than a predetermined price.

The output unit 113 outputs proposal information indicating the determination result by the determination unit 112. Examples of output formats for the proposal information include display on a display, recording on a storage medium, and printing to a sheet. Examples of the proposed information include a list whether or not the over firing operation is possible based on the operable time, whether or not the over firing operation is possible based on the Mahalanobis distance, and whether or not the over firing operation is possible based on the power selling price.

Here, the operation of the plant analyzer according to the present embodiment will be described.

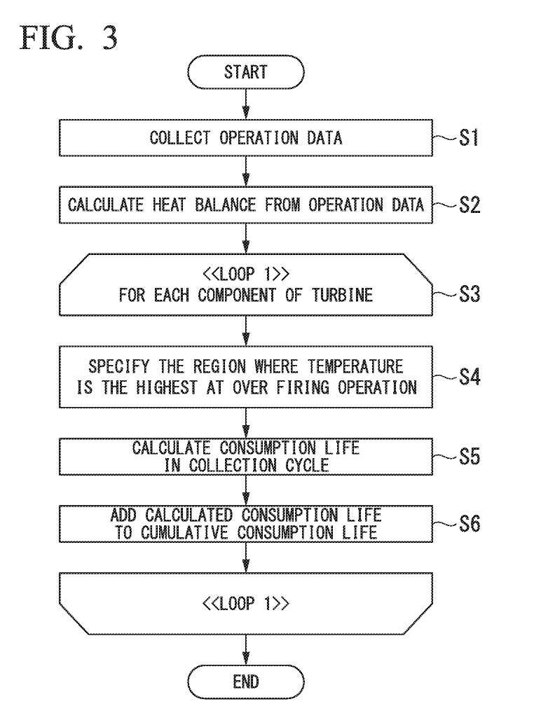

FIG. 3 is a flow chart showing an operation for each collection cycle of the plant analyzer according to the first embodiment.

The plant analyzer 1 performs the following processing for each collection cycle. First, the data collection unit 101 collects the operation data of the turbine from the sensor provided in the power plant 2, such as a turbine (Step S1). The heat balance calculation unit 102 calculates the heat balance of the power plant 2, such as a turbine, using the collected operation data as an input (Step S2).

Next, the plant analyzer 1 selects components of the turbine one by one, and performs the processing of Step S4 to Step S6 shown below for each of the selected components (Step S3).

First, the weak point specifying unit 103 specifies a region of the selected component that is the highest temperature during the over firing operation based on at least one of the current calculation result and the past calculation result of the heat balance calculation unit 102 (Step S4).

Next, the consumption life calculation unit 104 calculates a consumption life that denotes a temperature history during the latest collection cycle t of the selected component using a temperature T related to a region specified by the weak point specifying unit 103 in the heat balance calculated by the heat balance calculation unit 102 (Step S5). That is, the consumption life calculation unit 104 calculates the consumption life according to Equations (1) and (2) described above. The consumption life calculation unit 104 adds the calculated consumption life to the cumulative consumption life associated with the selected component stored in the consumption life storage unit 105 (Step S6). As a result, the consumption life calculation unit 104 updates the cumulative consumption life stored in the consumption life storage unit 105.

The plant analyzer 1 executes the processing from the above Step S1 to Step S6 for every collection cycle, so that the cumulative consumption life stored in the consumption life storage unit 105 can be kept in the latest state.

Here, the determining operation whether or not the over firing operation according to the plant analyzer 1 of the present embodiment is possible will be described.

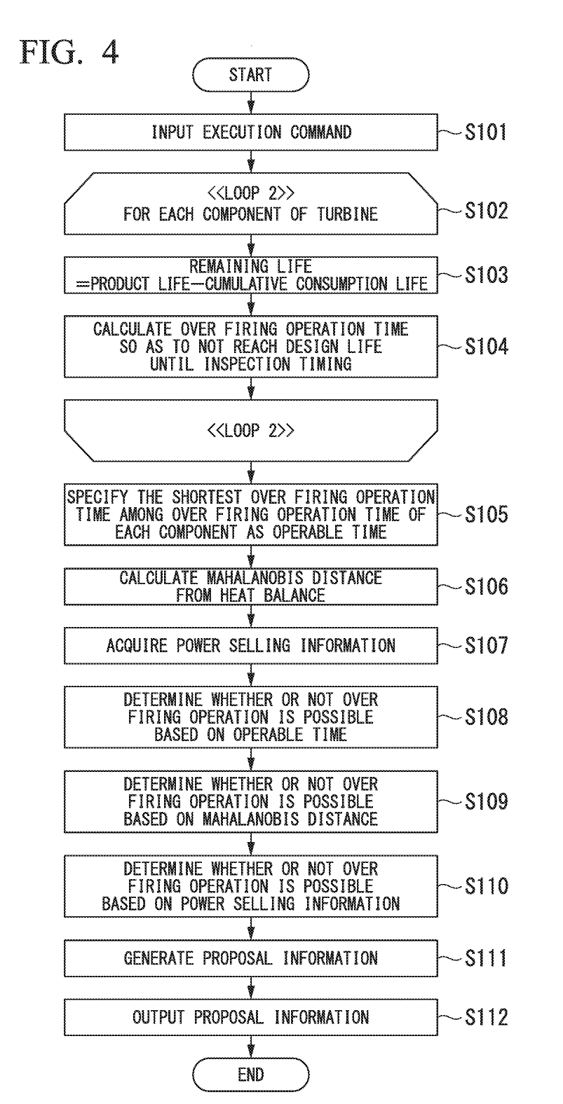

FIG. 4 is a flow chart showing the determining operation whether or not the over firing operation according to the plant analyzer according to the first embodiment is possible. When the operator inputs an execution command of a processing of determining whether or not the over firing operation in the plant analyzer 1 is possible, the input unit 106 receives input of the execution command (Step S101). The time calculation unit 109 selects one component of the turbine one by one, and performs the processing of steps S103 to S104 shown below for each of the selected component (Step S102).

First, time calculation unit 109 calculates the remaining life of the selected component by subtracting the cumulative consumption life associated with the selected component stored in the consumption life storage unit 105 from the product life associated with the selected component stored in the component life database 107 (Step S103). Next, the time calculation unit 109 calculates the maximum over firing operation time so that the selected component does not reach the design life during a period from the present time to the inspection timing (Step S104). That is, the time calculation unit 109 calculates the over firing operation time according to Equations (3) and (4) described above.

When the time calculation unit 109 executes the processing of Step S103 through Step S104 for all components, the shortest over firing operation time among the calculated over firing operation of each component is specified as the operable time which is for preventing the turbine from reaching the product life until the inspection timing (Step S105).

The distance calculation unit 110 calculates the Mahalanobis distance based on the latest heat balance calculated by the heat balance calculation unit 102 (Step 106). Further, the power selling information acquiring unit 111 acquires power selling information relating to the power selling price (Step 107).

The determination unit 112 determines whether the over firing operation of the turbine is possible based on the operable time calculated by the time calculation unit 109 (Step 108). Specifically, the determination unit 112 determines that the over firing operation should not be carried out when the operable time calculated by the time calculation unit 109 is less than a predetermined time (e.g., 1 hour). Next, the determination unit 112 determines whether or not the over firing operation of the turbine is possible based on the Mahalanobis distance calculated by the distance calculation unit 110 (Step 109). Specifically, the determination unit 112 determines that the over firing operation should not be carried out when the Mahalanobis distance exceeds a predetermined distance (e.g., 2). The determination unit 112 determines whether or not the over firing operation of the turbine is possible based on the power selling information acquired by the power selling information acquiring unit 111 (Step S110). Specifically, the determination unit 112 determines that the over firing operation should not be carried out when the power selling price indicated by the power selling information is less than a predetermined price (e.g., an annual average power selling price).

The output unit 113 generates a proposal information indicating each determination result based on the determination result of step S108 through step S110 by the determination unit 112 (Step S111). The output unit 113 outputs the generated proposal information (Step S112).

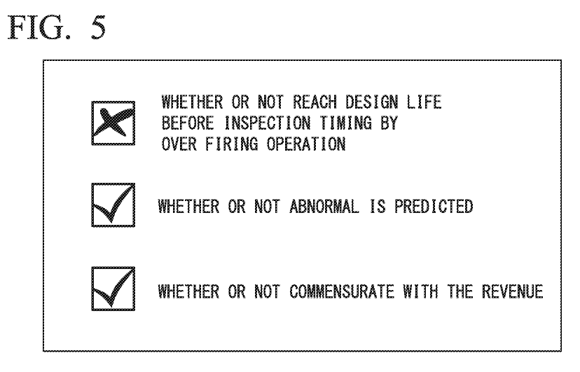

FIG. 5 is an example of the proposal information outputted by the plant analyzer according to the first embodiment.

As shown in FIG. 5, the output unit 113 outputs a list of whether or not the over firing operation is possible based on the operable time, whether or not the over firing operation is possible based on the Mahalanobis distance, and whether or not the over firing operation is possible based on the power selling price. Accordingly, it is possible for the operator to determine whether or not the turbine is allowed to carry out the over firing operation by referring to the proposal information. In addition, the operator may allow the turbine to carry out the over firing operation even in a case where some conditions indicate the over firing operation should not be carried out.

Thus, according to the present embodiment, the plant analyzer 1 calculates the operable time at the over firing operation of the turbine based on the design life of the turbine and the LMP value indicating the temperature history of the turbine. The turbine strain increases as temperature increases. Therefore, the plant analyzer 1 can accurately specify the remaining life of the turbine by managing the turbine life based on turbine temperature history. Accordingly, the plant analyzer 1 according to the present embodiment can accurately calculate the operable time in the over firing operation.

According to the present embodiment, the plant analyzer 1 determines whether or not the over firing operation of the turbine is possible based on the operable time. Accordingly, the operator of the power plant 2 can easily determine whether or not the turbine should carry out the over firing operation. In addition, the plant analyzer 1 according to the present embodiment outputs whether or not the over firing operation is possible as the proposal information, however it is not limited thereto. For example, the plant analyzer 1 according to another embodiment may automatically control the operation of the turbine according to the determination result of the determination unit 112. Further, the plant analyzer 1 according to still another embodiment may not determine whether or not the over firing operation of the turbine is possible, and may output the operable time. In still another embodiment, the plant analyzer 1 may calculate the operable time without using the LMP value. For example, the plant analyzer 1 according to still another embodiment may calculate the operable time based on a temperature history variable other than the LMP value.

Further, according to the present embodiment, the plant analyzer 1 calculates the operable time which is for preventing the turbine from reaching the product life until the inspection timing of the turbine. Accordingly, when the turbine carries out the over firing operation according to the operable time, the component that has reached the design life can be replaced at the next inspection timing. That is, by carrying out the over firing operation of the turbine according to the operable time, it is possible to reduce the possibility that the turbine cannot be operated before the next inspection timing.

According to the present embodiment, the plant analyzer 1 determines whether or not the over firing operation of the turbine is possible according to the Mahalanobis distance calculated based on the state quantity of the turbine. Since the over firing of the turbine is an operation at a higher load than the base load operation, there is a possibility that degradation other than creep may occur in the component. Therefore, the plant analyzer 1 determines whether or not the over firing operation of the turbine is possible by Mahalanobis distance, thereby it is possible to predict whether or not an abnormality occurs by over firing. Further, although there is no problem in continuing the base load operation, a threshold value used in a determination of the Mahalanobis distance may be lower than a threshold value used to detect the usual failure of the turbine, in order to predict a condition in which an abnormality can occur when switching to the over firing operation. On the other hand, the plant analyzer 1 according to another embodiment does not necessarily have to determine whether or not the over firing operation is possible based on the Mahalanobis distance.

According to the present embodiment, the plant analyzer 1 determines whether or not the over firing operation of the turbine is possible based on whether or not the power selling price is less than a predetermined threshold. That is, the plant analyzer 1 determines that the over firing operation is possible when the power selling price is relatively high. Accordingly, it is possible for the operator to allow the turbine carrying out the over firing operation when the over firing operation is commensurate with the revenue. On the other hand, the plant analyzer 1 according to another embodiment does not necessarily have to determine whether or not the over firing operation is possible based on power selling price.

According to the present embodiment, the plant analyzer 1 determines whether or not the over firing operation is possible based on a reference including the operable time and at least one of the Mahalanobis distance and the power selling price. As a result, it is possible to more appropriately determine whether or not the over firing operation is possible to carry out as compared with the case of determining whether or not the over firing operation is possible based on only the operable time.

### Second Embodiment

The second embodiment will be described in detail below with reference to the drawings. The plant analyzer 1 according to the first embodiment determines whether or not the over firing operation should be carried out based on the power selling price of the current time. On the other hand, a plant analyzer 1 according to the second embodiment outputs an operation schedule until the inspection timing based on the power selling price schedule indicating a daily power selling price. In the plant analyzer 1 according to the second embodiment, the plant analyzer 1 and the processing of the determination unit 112 differ from that of the first embodiment.

Here, a determination operation whether or not the over firing operation according to the plant analyzer 1 is possible will be described. In addition, an operation of each of the collection cycles according to the present embodiment is similar to that of the first embodiment.

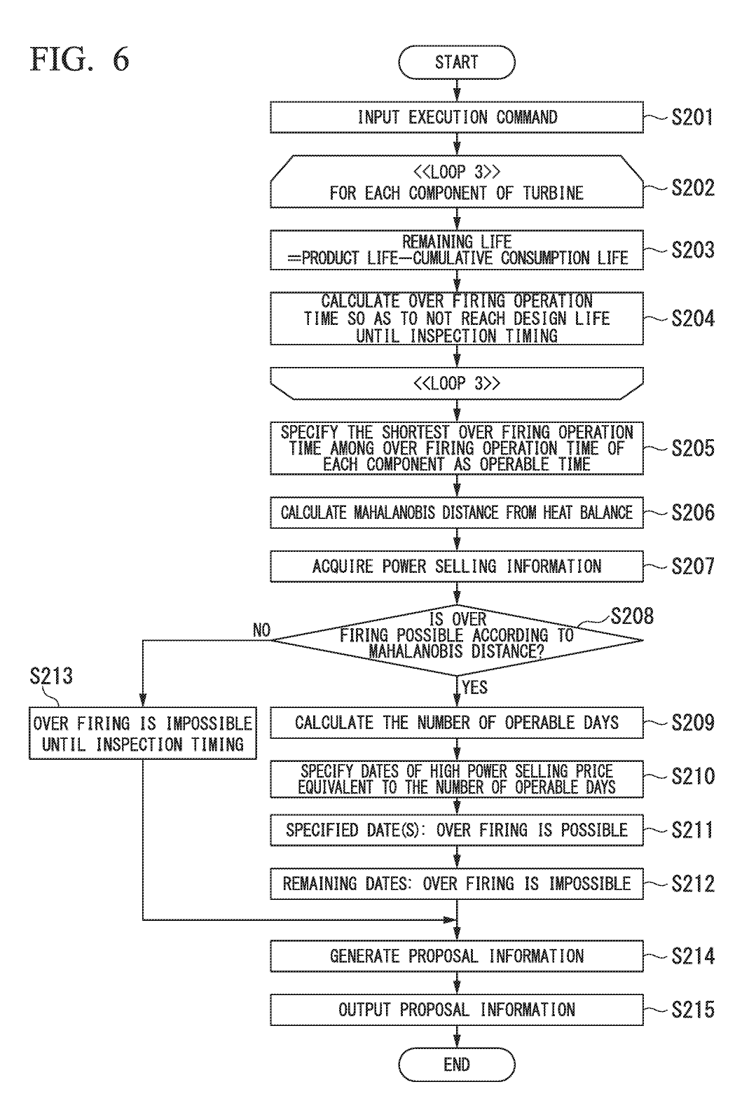

FIG. 6 is a flow chart showing the determination operation whether or not the over firing operation according to the plant analyzer according to the second embodiment is possible.

When the operator inputs the execution command of a processing of determining whether or not the over firing operation is possible in the plant analyzer 1, an input unit 106 receives input of the execution command (Step S201). Next, a time calculation unit 109 selects one component of the turbine one by one, and executes the processing of the steps S203 to S204 shown below for each of the selected components (Step S202).

First, the time calculation unit 109 calculates a remaining life of the selected component by subtracting a cumulative consumption life of the selected component stored in a consumption life storage unit 105 from the product life of the selected component stored in a component life database 107 (Step S203). Next, the time calculation unit 109 calculates the maximum over firing operation time based on the calculated remaining life and the inspection timing stored in inspection timing storage unit 108 so that the selected component does not reach the design life during a period from the present time to the inspection timing (Step S204).

When the time calculation unit 109 executes the processing from Step S203 to Step S204 for all components, the shortest over firing operation time among the calculated over firing operation time of each component is specified as the operable time which is for preventing the turbine from reaching the product life until the inspection timing (Step S205).

Next, a distance calculation unit 110 calculates a Mahalanobis distance based on the latest heat balance calculated by the heat balance calculation unit 102 (Step S206). Further, a power selling information acquiring unit 111 acquires a power selling price schedule indicating a transition of the daily power selling price as a power selling information (Step S207).

The determination unit 112 determines whether or not the over firing operation of the turbine is possible based on the Mahalanobis distance calculated by the distance calculation unit 110 (Step S208). Specifically, the determination unit 112 determines that the over firing operation should not be carried out in a case where the Mahalanobis distance exceeds a predetermined distance (e.g., 2).

When the determination unit 112 determines that the over firing operation is possible to carry out in a determination based on the Mahalanobis distance (Step S208: YES), the determination unit 112 divides the operable time calculated by the time calculation unit 109 by the operating duration per one day and calculates the number of operable days that is the number of days capable of carrying out the over firing operation (Step S209). Next, the determination unit 112 specifies the dates equivalent to the number of operable days in ascending order of the power selling price from the days during a period from the present to inspection timing based on the power selling price schedule acquired by the power selling information acquiring unit 111 (Step S210). Then, the determination unit 112 determines that the specified dates are the possible days of carrying out the over firing operation (Step S211). Further, the determination unit 112 determines that the remaining dates are the days which should not carry out the over firing operation (Step S212). That is, the determination unit 112 determines whether or not the over firing operation is possible for each day from the present to the inspection timing based on the operable time calculated by the time calculation unit 109 and the power selling price acquired by the power selling information acquiring unit 111.

On the other hand, when the determination unit 112 determines that the over firing operation should not be carried out in a determination based on the Mahalanobis distance (Step S208: NO), the determination unit 112 determines that each day from the present to the inspection timing is a day on which the over firing should not be operated (Step 213).

The output unit 113 generates a proposal information indicating an operation schedule based on the determination result of Step S211 and Step S212 of the determination unit 112, or the determination result of Step S213 (Step S214). That is, the operation schedule proposes the over firing operation on the days determined as a possible day of the over firing operation. The operation schedule proposes the base load operation on the days on which the over firing operation should not be carried out. The output unit 113 outputs the generated proposal information (Step S215).

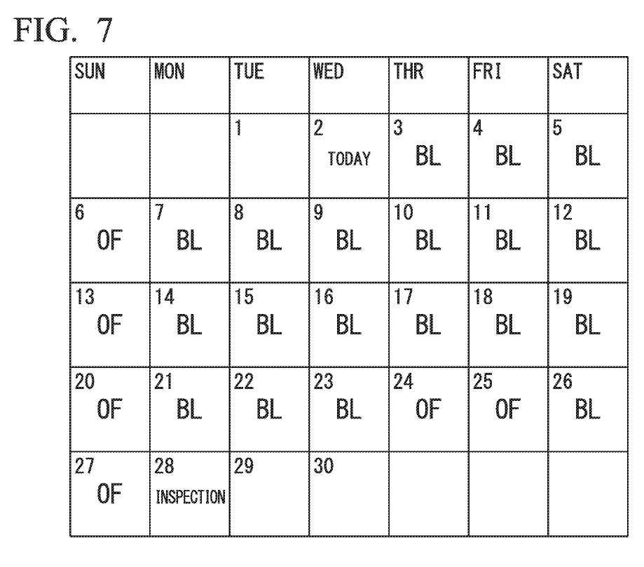

FIG. 7 is an example of the proposal information outputted by the plant analyzer according to the second embodiment.

As shown in FIG. 7, the output unit 113 outputs an operation schedule from present to the inspection timing as the proposal information. The proposal information shown in FIG. 7 proposes an over firing operation on the day of 6, 13, 20, 24, 25, and 27 (“OF (Over Firing)” in FIG. 7), and proposes a base load operation for the remaining days (“BL (Base Load)” in FIG. 7). Accordingly, it is possible for the operator to determine whether or not the over firing operation of the turbine is possible by referring to the proposal information. In addition, the operator may carry out the over firing operation of the turbine even in a case where a day is a non-proposed day of the over firing operation in the proposal information.

In this manner, according to the present embodiment, the plant analyzer 1 determines whether or not the over firing operation is possible for each day from the present to the inspection timing based on the operable time and power selling price schedule in the over firing operation. As a result, the plant analyzer 1 can generate the operating schedule with the highest revenue.

### Third Embodiment

The third embodiment will be described in detail below with reference to the drawings. The plant analyzer 1 according to the third embodiment determines the inspection timing of the turbine when the turbine continues the over firing operation. That is, the inspection timing of the turbine according to the first embodiment is the time stored in the inspection timing storage unit 108. On the other hand, the inspection timing of the turbine according to the third embodiment is determined by the plant analyzer 1.

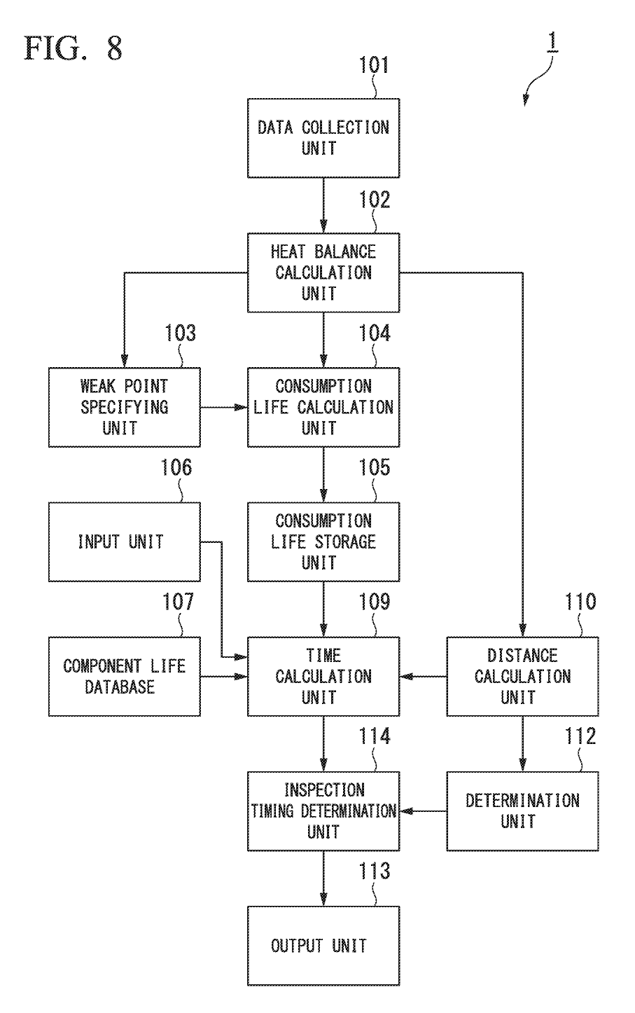

FIG. 8 is a schematic block diagram showing a configuration of a plant analyzer according to a third embodiment.

The plant analyzer 1 according to the third embodiment further comprises an inspection timing determination unit 114 in addition to the configuration of the first embodiment. The inspection timing determination unit 114 determines the inspection timing of the turbine based on the operable time calculated by the time calculation unit 109. On the other hand, the plant analyzer 1 according to the third embodiment does not have the inspection timing storage unit 108 and the power selling information acquiring unit 111 among the configuration of the first embodiment. In the plant analyzer 1 according to the third embodiment, the operation of the time calculation unit 109 and the output unit 113 differs from that of the first embodiment.

Here, the determining operation of the inspection timing according to the plant analyzer according to the present embodiment will be described. The operation of each of the collection cycles according to the present embodiment is similar to that of the first embodiment.

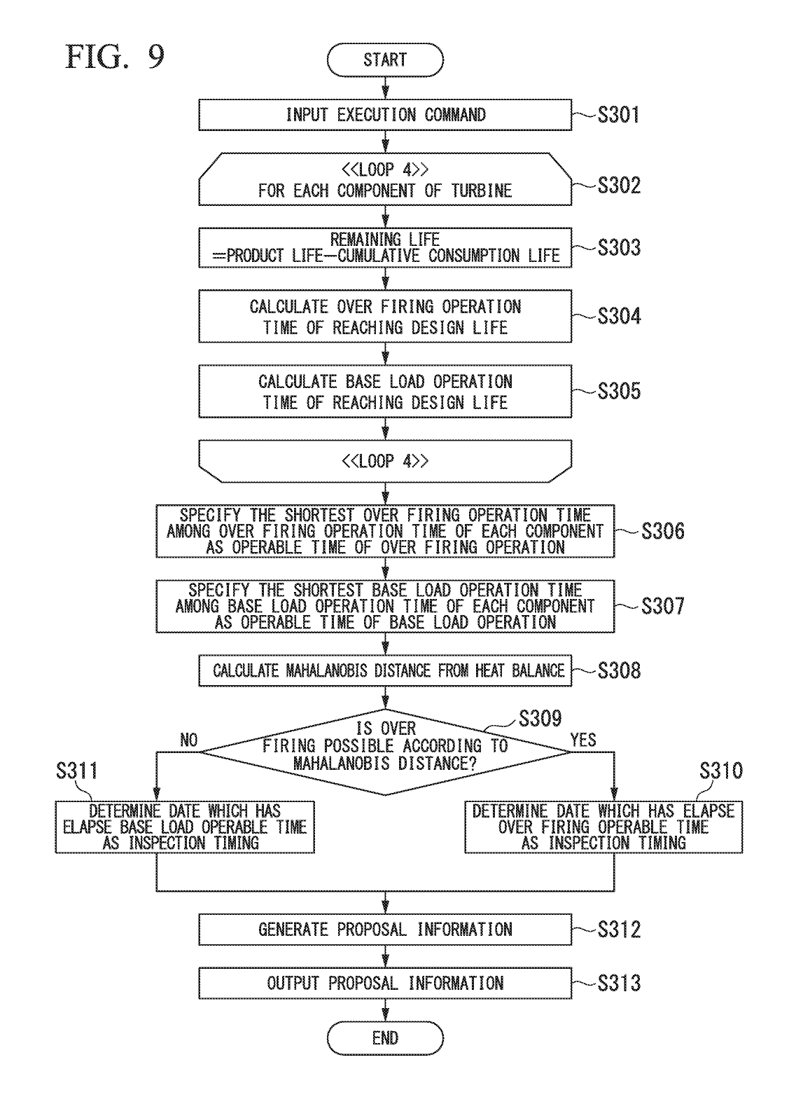

FIG. 9 is a flow chart showing the determination operation of the inspection timing by the plant analyzer according to the third embodiment.

When the operator inputs an execution command of a processing determining the inspection timing in the plant analyzer 1, the input unit 106 receives the input of the execution command (Step S301). Next, the time calculation unit 109 selects components of the turbine one by one and executes the processing of Step S303 to S305 shown below for each of the selected components (Step S302).

First, the time calculation unit 109 calculates the remaining life of the selected component by subtracting the cumulative consumption life of the selected component stored in consumption life storage unit 105 from the product life of the selected component stored in the component life database 107 (Step S303). Next, on the basis of the calculated remaining life, the time calculation unit 109 calculates the over firing operation time which is a time until the selected component reaches the design life, when the over firing operation is continuously carried out from the current time (Step S304). Further, the time calculation unit 109 calculates the base load operation time which is a time until the selected component reaches the design life when the base load operation continues from the present time based on the calculated remaining life (Step S305).

When the time calculation unit 109 executes the processing of Step S303 to Step S305 for all components, the shortest over firing operation time among the calculated over firing operation time of each component is specified as the over firing operable time until the turbine reaches the product life (Step S306). Further, the time calculation unit 109 specifies the shortest base load operation time among the calculated base load operation time of each component as a base load operable time until the turbine reaches the product life (Step S307).

The distance calculation unit 110 calculates the Mahalanobis distance based on the latest heat balance calculated by the heat balance calculation unit 102 (step S308). Next, the determination unit 112 determines whether or not the over firing operation of the turbine is possible based on the Mahalanobis distance calculated by the distance calculation unit 110 (Step S309). Specifically, the determination unit 112 determines that the over firing operation should not be carried out when the Mahalanobis distance exceeds a predetermined distance (e.g., 2).

When the determination unit 112 determines that the over firing operation is possible in the determination based on the Mahalanobis distance (Step S309: YES), the inspection timing determination unit 114 determines the date when the over firing operable time has elapsed from the present time as the inspection timing (Step S310). On the other hand, when the determination unit 112 determines that the over firing operation should not be carried out in the determination based on the Mahalanobis distance (Step S307: NO), the inspection timing determination unit 114 determines the date when the base load operable time has elapsed from the present time as the inspection timing (Step S311).

The output unit 113 generates the proposal information indicating the determination result by the determination unit 112 and the inspection timing determined by the inspection timing determination unit 114 (Step S312). In other words, the proposed information proposes whether or not the over firing operation is possible and the next inspection timing. Next, the output unit 113 outputs the generated proposal information (Step S313).

In this manner, according to the present embodiment, the plant analyzer 1 determines the inspection timing based on the over firing operable time. Thus, the plant analyzer 1 can set the inspection timing at an appropriate time even when the turbine is always operated in a state of the over firing. Further, according to the present embodiment, when the plant analyzer 1 determines that the over firing should not be carried out based on the Mahalanobis distance, the plant analyzer 1 determines the inspection timing based on the base load operable time. As a result, when the plant analyzer 1 determines that there is a possibility of occurrence of abnormal due to the over firing operation, the plant analyzer 1 is possible to propose the base load operation and set the inspection timing at an appropriate time for the base load operation.

Although the drawings have been described in detail with reference to the drawings, specific configurations are not limited to those described above, and various design changes can be made.

For example, in the above-described embodiment, the weak point specifying unit 103 specifies the region where the temperature is highest at the over firing operation; however, it is not limited thereto. For example, in another embodiment, the highest temperature region in the over firing operation may specified in advance by a turbine designer or the like. Further, the consumption life calculation unit 104 according to still another embodiment may calculate the LMP value based on other temperatures such as an average temperature of the component, not at the temperature of the region where the temperature is highest at the over firing operation.

Further, in the above embodiment, the plant analyzer 1 uses the LMP value as a temperature history variable to determine whether or not the component will reach the life of the component by the creep deformation; however, it is not limited thereto. For example, another embodiment may use another temperature history variable. For example, a plant analyzer 1 according to the other embodiment may use a temperature history variable indicating a relationship between a temperature and the number of cycles to determine whether or not a component reaches a life by low-cycle fatigue. Further, the plant analyzer 1 according to still another embodiment may use a plurality of temperature history variables to determine whether or not a component reach a life based on a plurality of deterioration reasons, such as creep deformation and low-cycle fatigue.

Also, in the embodiments described above, based on the over firing operation time for each component constituting the turbine, the plant analyzer 1 calculates the operable time at the over firing operation of the entire turbine; however, it is not limited thereto. For example, the plant analyzer 1 according to another embodiment may directly calculate the operable time at the over firing operation of the entire turbine based on the design life of the entire turbine, without calculating the over firing operation time of each component.

In the above-described embodiment, the weak point specifying unit 103, the consumption life calculation unit 104, and the distance calculation unit 110 calculate based on the heat balance calculated by the heat balance calculation unit 102; however, it is not limited thereto. For example, in another embodiment, at least one of the weak point specifying unit 103, the consumption life calculation unit 104, and the distance calculation unit 110 may perform calculations based on the operation data collected by the data collection unit 101.

In particular, in another embodiment, when all of the weak point specifying unit 103, the consumption life calculation unit 104, and the distance calculation unit 110 perform calculations based on the operation data collected by data collection unit 101, the plant analyzer 1 may not calculate the heat balance by the heat balance calculation unit 102.

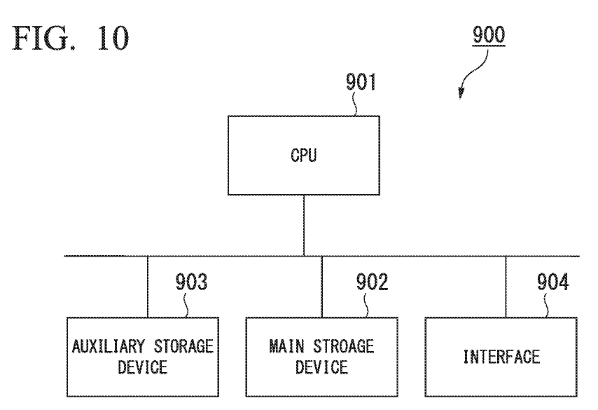

FIG. 10 is a schematic block diagram showing a configuration of a computer according to at least one embodiment.

The computer 900 includes a CPU 901, a main storage device 902, an auxiliary storage device 903, and an interface 904.

The plant analyzer 1 described above is implemented in the computer 900. The operation of each of the above-described processing units is stored in the auxiliary storage device 903 in the form of a program. The CPU 901 reads out the programs from the auxiliary storage device 903 to the main storage device 902 and executes the process according to the programs. In accordance with the programs, the CPU secures a storage area corresponding to the inspection timing storage unit 108 and the consumption life storage unit 105 in main storage device 902. In accordance with the programs, the CPU 901 secures a storage area corresponding to the component life database 107 to the auxiliary storage device 903.

In addition, in at least one embodiment, the auxiliary storage device 903 is an example of a non-transitory tangible medium. Other examples of non-transitory tangible media include a magnetic disk, a magneto-optical disk, a CD-ROM, a DVD-ROM, a semiconductor memory, etc. connected via the interface 904. When the program is delivered to the computer 900 via a communication line, the computer 900 that has received the delivery may develop the program in the main storage device 902 and may execute the above processes.

The program may also be used to realize part of the functions mentioned above. Further, the program may be a difference file (difference program) that realizes the above-described function in combination with other programs already stored in the auxiliary storage device 903.

### INDUSTRIAL APPLICABILITY

According to at least one aspect of the above described aspects, the plant analyzer can accurately calculate the operable time at the over firing operation.

### EXPLANATION OF REFERENCE SIGN

1: Plant Analyzer
101: Data Collection Unit
102: Heat Balance Calculation Unit
103: Weak Point Specifying Unit
104: Consumption Life Calculation Unit
105: Consumption Life Storage Unit
106: Input Unit
107: Component Life Database
108: Inspection Timing Storage Unit
109: Time Calculation Unit
110: Distance Calculation Unit
111: Power Selling Information Acquiring Unit
112: Determination Unit
113: Output Unit
114: Inspection Timing Determination Unit
900: Computer
901: CPU
902: Main Storage Device
903: Auxiliary Storage Device
904: Interface

1. A plant analyzer comprising:
a state quantity acquiring unit configured to acquire a state quantity of a turbine including a temperature of the turbine;
a variable calculation unit configured to calculate a history variable with respect to a history of the state quantity; and
a time calculation unit configured to calculate an operable time at an over firing operation of the turbine based on a history variable corresponding to a design life of the turbine and a calculated history variable.

2. The plant analyzer according to claim 1, further comprising:
a first determination unit configured to determine whether or not the over firing operation of the turbine is possible based on the operable time calculated by the time calculation unit.

3. The plant analyzer according to claim 1,
wherein the time calculation unit is configured to calculate the operable time to prevent the turbine from reaching a product life until an inspection timing of the turbine.

4. The plant analyzer according to claim 1, further comprising:
an inspection timing determination unit configured to determine the inspection timing of the turbine based on the operable time calculated by the time calculation unit.

5. The plant analyzer according to claim 1, further comprising:
a distance calculation unit configured to calculate a Mahalanobis distance based on the state quantity; and
a second determination unit configured to determine whether or not the over firing operation of the turbine is possible by the Mahalanobis distance.

6. The plant analyzer according to claim 1, further comprising:
a third determination unit configured to determine whether or not the over firing operation of the turbine is possible based on whether or not a power selling price is less than a predetermined threshold.

7. A plant analysis method comprising the steps of:
acquiring a state quantity of a turbine including a temperature of the turbine;
calculating a history variable with respect to a history of the state quantity; and
calculating an operable time at an over firing operation of the turbine based on a history variable corresponding to a design life of the turbine and a calculated history variable.

8. A non-transitory computer-readable computer medium storing a program causing a computer to function as:
a state quantity acquiring unit configured to acquire a state quantity of a turbine including a temperature of the turbine;
a variable calculation unit configured to calculate a history variable with respect to a history of the state quantity; and
a time calculation unit configured to calculate an operable time at an over firing operation of the turbine based on a history variable corresponding to a design life of the turbine and the calculated history variable.
